(19) United States
(12) Patent Application Publication
(10) Pub. No.: US 2012/0295134 A1
(43) Pub. Date: Nov. 22, 2012

(54) PERFLUOROPOLYETHER COMPOUND, MANUFACTURING METHOD THEREFOR, LUBRICANT CONTAINING SAID COMPOUND, AND MAGNETIC DISC

(75) Inventors: Akinobu Wakabayashi, Kobe-shi (JP); Haruo Kasai, Kobe-shi (JP)

(73) Assignee: MORESCO CORPORATION, Kobe-shi (JP)

(21) Appl. No.: 13/575,195

(22) PCT Filed: Feb. 10, 2010
(86) PCT No.: PCT/JP2010/051988

§ 371 Date: Jul. 25, 2012

(51) Int. Cl. G11B 5/725; G11B 5/84

(52) U.S. Cl. 428/833; 427/558

(57) ABSTRACT

An object of the present invention is to provide a compound (lubricant) that exhibits better fluidity and adsorbability on the surface of a disk than conventional end-modified compounds, that is thermally stable, and that is obtained by introducing an additional functional group to the end(s) of a perfluoropolyether having a hydroxy group.

The present invention relates to a lubricant comprising a perfluoropolyether compound containing, in the molecule, a group represented by Formula (2), wherein R represents a hydrogen, a C₁₋₁₀ alkyl group, or an alkoxy group, and n is 1 or 2.

Formula (2):

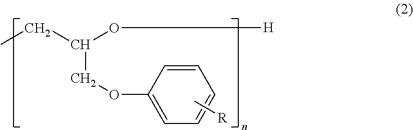

### TECHNICAL FIELD

The present invention relates to a perfluoropolyether compound, manufacturing method thereof, a lubricant containing the compound, and a magnetic disk.

### BACKGROUND ART

Along with an increase in the recording density of magnetic disks, the clearance between a magnetic disk (i.e., recording medium) and a head for recording and reading information has become so narrow that the disk and head are almost in contact with each other. A carbon protection film and an ultra-thin liquid lubrication film are provided on the surface of the magnetic disk in order to reduce the abrasion attributable to the contact with the head and to sliding of head and disk, prevent contamination on the surface of the disk, etc.

The carbon protection film is generally formed by sputtering or CVD. Protection of the surface of a disk is to be performed by a carbon protection film and a liquid lubrication film disposed on the carbon protection film; therefore, interaction between the carbon protection film and lubricant is important.

As the lubricant, perfluoropolyether containing a functional group is usually used. Examples of functional groups include hydroxy group, amino group, cyclophosphazene group, etc. Specifically, an example of the lubricant having a plurality of hydroxy groups at the ends of the molecular chain is Fomblin ZTETRAOL produced by Solvay Solexis K.K; an example of the lubricant having a hydroxy group at one end and a cyclophosphazene group at the other end of the molecule is PHOSFAROL A20H produced by Matsumura Oil Research Corp.; and the like (see, for example, Patent Literature 1 and Patent Literature 2).

Fomblin ZDOL having one hydroxy group at each end of its molecular chain exhibits excellent lubricant film fluidity; however, spin-off of a large amount of lubricant is observed on a disk rotating at a high speed, and the lubricant film cannot be preserved for a long period of time. Unlike Fomblin ZDOL, Fomblin ZTETRAOL, which is produced by modifying the end groups of ZDOL, exhibits excellent adsorbability to a disk attributable to four hydroxy groups located at both ends of the molecule; therefore, spin-off of lubricant is not observed even when a disk is rotated at a high speed, and the lubricant film can be preserved. However, fluidity of lubricant film is reduced, and sliding durability becomes insufficient. Furthermore, the functional groups introduced by modifying the end groups are apt to be denatured (oxidized) by heating (see, for example, Non-patent Literature 1).

The PHOSFAROL A20H contains, in its molecule, a cyclophosphazene group, which suppresses the cleavage of the main chain of perfluoropolyether due to Lewis acid. This suppresses the decomposition of the compound attributable to Al₂O₃ contained in a component of the head; therefore, the lubricant film on a disk can be preserved (see, for example, Patent Literature 2 and Non-patent Literature 2). There are some reports that the durability of lubricant (film) can be increased by the addition of PHOSFAROL A20H (see, for example, Patent Literature 3).

When the number of polar groups, such as hydroxy group, in the molecule of lubricant increases, the interaction between the lubricant and a carbon protection film increases; however, this reduces the fluidity of the lubricant. When the fluidity is remarkably reduced, the lubricity (film) becomes insufficient under the lubrication conditions where the disk and the head are almost in contact with each other, and this may impair the durability of the magnetic disk.

It is known that the lubricant adheres to the surface of the disk, because the hydroxy group contained in lubricant forms a hydrogen bond with the hydroxy group contained in a carbon protection film, or forms a covalent bond with a dangling bond (unpaired electron) (see, for example, Non-patent Literature 3).

In recent years, in order to strengthen the adhesion of the lubricant to the surface of a disk, instead of conventional heat treatment, an ultraviolet treatment is generally employed.

### CITATION LIST

### Patent Literature

PTL 1: U.S. Pat. No. 4,085,137
PTL 2: U.S. Pat. No. 6,608,009
PTL 3: US Patent Application No. 2008/0176106

### Non-Patent Literature

NPL 1: JAST Tribology Conference, Nagoya, September 2008 to 2009, pp. 419-420
NPL 2: Macromolecules, Vol. 25, 1992, pp. 6791-6799
NPL 3: Tribology Letters, Vol. 26, 2007, pp. 93-101

### SUMMARY OF INVENTION

### Technical Problem

An object of the present invention is to provide a compound (lubricant) that exhibits fluidity and adsorbability on the surface of a disk better than those of conventional end-modified compounds, and is thermally stable. Such a compound (lubricant) is obtained by introducing an additional functional group to the end(s) of a perfluoropolyether having a hydroxy group.

### Solution to Problem

In order to solve the above problems, a novel lubricant was synthesized using a perfluoropolyether having hydroxy group(s) at its end(s) as the starting material, and the properties thereof were evaluated. As a result, the present inventors found that a perfluoropolyether compound having a specific functional group at the end(s) of the perfluoropolyether chains can solve the above problems. The present invention has been accomplished based on this finding.

More specifically, the present invention provides the following perfluoropolyether compounds, a production method thereof, a lubricant containing the compound, and a magnetic disk.

Item 1. A perfluoropolyether compound represented by Formula (1):

A-O—CH₂—CF₂O—(CF₂CF₂O)ₚ—(CF₂O)_{q}—CF₂—CH₂—O-A (1)

wherein p is an integer of 1 to 30, q is an integer of 0 to 30, and A is a group represented by Formula (2):

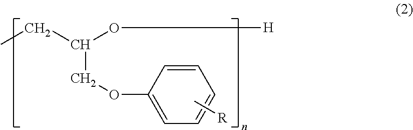

wherein R represents a hydrogen, a C₁₋₁₀ alkyl group, or a C₁₋₁₀ alkoxy group, and n is 1 or 2.

Item 2. A lubricant comprising a perfluoropolyether compound, in its molecule, containing a group represented by Formula (2):

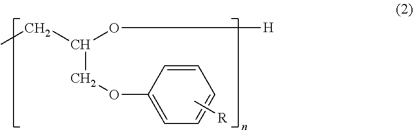

wherein R represents a hydrogen, a C₁₋₁₀ alkyl group, or a C₁₋₁₀ alkoxy group, and n is 1 or 2.

Item 3. A lubricant comprising a perfluoropolyether compound represented by Formula (1):

A-O—CH₂—CF₂O—(CF₂CF₂O)ₚ—(CF₂O)_{q}—CF₂—CH₂—O-A (1)

wherein p is an integer of 1 to 30, q is an integer of 0 to 30, and A is a group represented by Formula (2):

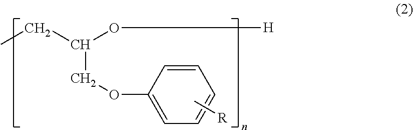

wherein R represents a hydrogen, a C₁₋₁₀ alkyl group, or a C₁₋₁₀ alkoxy group, and n is 1 or 2.

Item 4. A process for manufacturing a perfluoropolyether compound, in its molecule, containing a group represented by Formula (2):

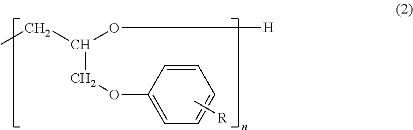

wherein R represents a hydrogen, a C₁₋₁₀ alkyl group, or a C₁₋₁₀ alkoxy group and n is 1 or 2;

the process comprising reacting a perfluoropolyether having a hydroxy group at the end or ends with an epoxy compound, for each hydroxy group, represented by Formula (3):

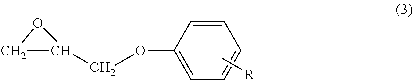

wherein R is as defined above.

Item 5. A magnetic disk comprising:

a substrate;

a recording layer and a protective layer formed on the substrate in this order; and

a lubricant layer containing the lubricant of Item 2 or 3 formed on the surface of the protective layer.

### Advantageous Effects of Invention

The perfluoropolyether compound of the present invention exhibits better fluidity and adsorbability than conventional Fomblin ZTETRAOL; therefore, by applying a lubricant comprising the compound, magnetic disks having excellent durability and/or little spin-off can be provided. Furthermore, because the perfluoropolyether compound of the present invention is very stable against heating, a lubricant film that is not easily denaturalized even when used under a high temperature for a long period of time can be provided.

### BRIEF DESCRIPTION OF DRAWINGS

FIG. 1 is a schematic cross-sectional view illustrating one example of the magnetic disk of the present invention.

### DESCRIPTION OF EMBODIMENTS

The present invention is explained in detail below.

Because an aromatic ring is introduced into the end(s) of the perfluoropolyether compound contained in the lubricant of the present invention, the lubricant of the present invention exhibits an interaction with the carbon protection film. Furthermore, by using a phenoxy group as the aromatic ring introduced, the force of interaction between the lubricant and the carbon protection film can be increased. Further, responsiveness to an ultraviolet treatment can be attained. The functional group introduced is not only a phenoxy group; a hydroxy group is also introduced at the same time.

The perfluoropolyether compound contained in the lubricant of the present invention maintains its fluidity by not increasing the number of hydroxy groups compared to Fomblin ZDOL (i.e., the number of hydroxy groups is 2), which is one example of the starting material for the perfluoropolyether compound.

The perfluoropolyether compound of the present invention comprises a functional group at the end(s) represented by Formula (2) that contains a phenoxy group and a hydroxy group.

The C₁₋₁₀ alkyl group represented by R in Formula (2) is preferably methyl group, etc. A methoxy group, etc. is preferable as C₁₋₁₀ alkoxy group.

In the perfluoropolyether compound represented by Formula (1), p is preferably 5 to 22, and q is preferably 5 to 22.

The perfluoropolyether compound of the present invention is produced, for example, by the process described below.

Production of perfluoropolyether compound represented by Formula

A-O—CH₂—CF₂O—(CF₂CF₂O)ₚ—(CF₂O)_{q}—CF₂—CH₂—O-A (1)

Perfluoropolyether of HO—CH₂—CF₂O—(CF₂CF₂O)ₚ—(CF₂O)_{q}—CF₂—CH₂—OH having a hydroxy group at both ends of the molecular chain, potassium t-butoxide, and t-butanol are mixed and stirred at 70° C. for 30 minutes. After the potassium t-butoxide is dissolved, 0.5 to 3.0 equivalent amount of 1,2-epoxy-3-phenoxypropane was gradually added thereto over 1 hour at 70° C. while stirring. After the completion of dropwise addition, the mixture was further stirred at 70° C. for 5 hours or more. After the completion of the reaction, extraction is performed using a fluorine solvent such as a fluorocarbon-based solvent, and the solvent is then removed by distillation to obtain a viscous liquid. The viscous liquid thus obtained comprises a perfluoropolyether compound represented by Formula (1), a perfluoropolyether compound represented by Formula (4): A-O—CH₂—CF₂O—(CF₂CF₂O)ₚ—(CF₂O)_{q}—CF₂—CH₂—OH, and an unreacted raw material.

Examples of the starting materials for perfluoropolyether include Fomblin ZDOL (structural formula: HO—CH₂—CF₂O—(CF₂CF₂O)ₚ—(CF₂O)_{q}—CF₂—CH₂—OH) produced by Solvay Solexis K.K., and the like. The number average molecular weight of perfluoropolyether is about 1,000 to 10,000.

Examples of epoxy compounds usable as reactants include 2,3-epoxypropyl-4-methoxyphenyl ether, glycidyl-4-nonylphenyl ether, and the like.

The mixture after the completion of the reaction may be used as a lubricant as is; and it may also be used after isolation by column chromatography, supercritical carbon dioxide extraction, molecular distillation (thin-film distillation by heating) and the like.

The lubricant comprising a perfluoropolyether compound preferably contains the perfluoropolyether compound represented by Formula (1) in a proportion of 80% by weight or more, and more preferably 90% by weight or more.

Production of other perfluoropolyether compounds comprising a group represented by Formula (2)

Examples of perfluoropolyethers usable as the starting materials include those having a hydroxy group at one end of the molecular chain, such as CF₃CF₂CF₂O—(CF₂CF₂CF₂O)ₘ—CF₂—CF₂—CH₂—OH and B—CH₂—CF₂O—(CF₂CF₂O)ₚ—(CF₂O)_{q}—CF₂—CH₂—OH. Here, B in the formulae is a group represented by Formula (5) below.

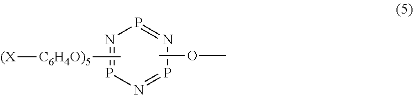

Examples of perfluoropolyethers usable as the starting materials include DEMNUM-SA (structural formula: CF₃CF₂CF₂O—(CF₂CF₂CF₂O)ₘ—CF₂—CF₂—CH₂—OH) produced by Daikin Industries Ltd., PHOSFAROL A20H (structural formula: B—CH₂—CF₂O—(CF₂CF₂O)ₚ—(CF₂O)_{q}—CF₂—CH₂—OH, wherein B is a group represented by Formula (5) above, and X in Formula (5) is CF₃—) produced by Matsumura Oil Research Corporation, and the like. The number average molecular weight of the perfluoropolyether is about 1,000 to 10,000.

HO—CH₂—CF₂—CF₂O—(CF₂CF₂CF₂O)ₘ—CF₂—CF₂—CH₂—OH, which has a hydroxy group at both ends of the molecular chain, may also be usable as the starting material for perfluoropolyether.

One example of the application of the perfluoropolyether compound of the present invention is a lubricant for recording media for improving the sliding properties of a magnetic disk in a magnetic disk unit. Such an application aims to reduce the coefficient of friction between the magnetic disk and the head; therefore, the perfluoropolyether compound of the present invention may also be used as a lubricant for use in a recording unit other than a magnetic disk, wherein sliding occurs between a magnetic tape or like recording medium and a head. The lubricant of the present invention may be used as a lubricant for a unit, not limited to a recording unit, that comprises a part involved in sliding.

The perfluoropolyether compound of the present invention may be used alone or in, combination with other compounds at an arbitrary mixing ratio. Examples of usable compounds include Fomblin ZDOL, ZTETRAOL, ZDOL-TX, and AM produced by Solvay Solexis K.K.; DEMNUM produced by Daikin Industries Ltd.; KRYTOX produced by DuPont; PHOSFAROL A20H produced by Matsumura Oil Research Corporation; etc.

The magnetic disk of the present invention comprises a recording layer and a protective layer formed on a substrate in this order, and a lubricant layer formed on the surface of the protective layer.

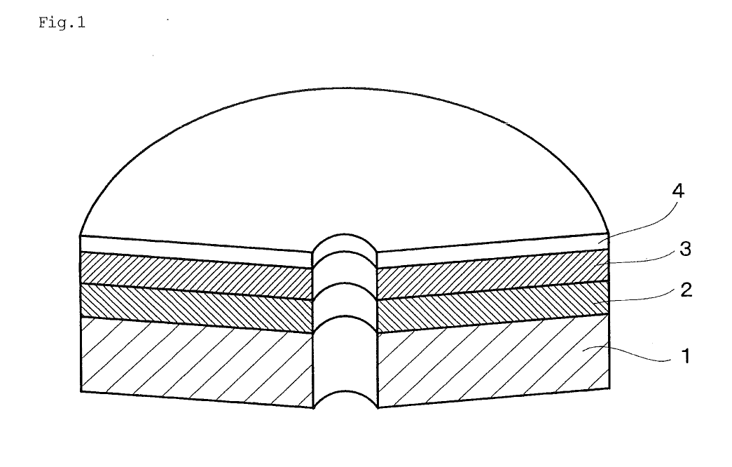

FIG. 1 shows a schematic view (cross-section) of an example of the magnetic disk of the present invention.

In FIG. 1, the magnetic disk of the present invention comprises a substrate 1, a recording layer 2 formed on the substrate 1, a protective layer 3 formed on the recording layer 2, and a lubricant layer 4 containing the lubricant for recording media as the outermost layer.

Examples of the materials for the substrate 1 include aluminum alloys, glass, polycarbonate and the like. Examples of the materials for the recording layer 2 include alloys obtained by adding chromium, platinum, tantalum or the like to an element that can form a ferromagnetic such as iron, cobalt, and nickel, and oxides of such alloys. These materials are formed by plating, sputtering or the like. Examples of the materials for the protective layer 3 include diamond-like carbon, Si₃N₄, SiC, SiO₂, and the like. These materials are formed by plating, CVD or the like.

The lubricant layer 4 is produced by dissolving the perfluoropolyether compound of the present invention or a lubricant containing the compound in a solvent, and immersing the subject disk into the resulting solution. Examples of solvents include those that dissolve the perfluoropolyether compound of the present invention or a lubricant containing the compound. Specific examples thereof include fluorocarbon-based solvents (e.g., “PF-5060,” “PF-5080,” “HFE-7100,” “HFE-7200,” and “HFE-7300” produced by Sumitomo 3M Limited; and “VERTREL XF” produced by DuPont) and the like. The concentration of the perfluoropolyether compound in the solution is preferably 1% by weight or less, more preferably within the range of 0.001 to 0.1% by weight.

### EXAMPLES

The present invention is explained in detail below with reference to Examples.

### Example 1

Production of perfluoropolyether compound (Compound 1) represented by Formula (1) wherein R is a hydrogen and n is 1

50.0 g (0.024 mol) of “Fomblin ZDOL” (produced by Solvay Solexis K.K.), 1.1 g (0.010 mol) of potassium t-butoxide, and 45.0 g of t-butanol were mixed and stirred at 70° C. for 30 minutes under an argon atmosphere. After confirming that potassium t-butoxide was dissolved, a 2.4 equivalent amount (i.e., 8.8 g, 0.059 mol) of 1,2-epoxy-3-phenoxypropane was gradually added thereto dropwise at 70° C. over 1 hour wile stirring. After the completion of dropwise addition, the mixture was further stirred at 70° C. for 7.5 hours. After the completion of the reaction, “VERTREL XF,” produced by DuPont, was added to the reaction mixture, followed by extraction. The extract was washed with 3% by weight of nitric acid solution and pure water. The “VERTREL XF” was removed by distillation to obtain 57.2 g of a viscous liquid. Furthermore, unreacted raw material was removed by molecular distillation purification to obtain 52.0 g of objective Compound 1.

Compound 1 was a colorless transparent liquid. The identification results of Compound 1 using ¹H-NMR analysis and ¹⁹F-NMR analysis are shown below.

The ¹H-NMR analysis results are shown below.

¹H-NMR (solvent: perfluorobenzene, reference material: deuterium D₂O):

δ=2.87 ppm

[1H, Rf—[—CF₂—CH₂—O—CH₂—CH(—CH₂—OC₆H₅)—OH]],

δ=3.45-4.15 ppm

[7H, Rf—[—CF₂—CH₂—O—CH₂—CH(—CH₂—OC₆H₅)—OH]],

δ=6.40-7.00 ppm

[5H, Rf—[—CF₂—CH₂—O—CH₂—CH(—CH₂—OC₆H₅)—OH]].

The ¹⁹F-NMR analysis results are shown below.

¹⁹F-NMR (solvent and reference material: perfluorobenzene):

δ=−77.00 ppm

[2F, Rf—[—CF₂CF₂O—CF₂—CH₂—O—CH₂—CH(—CH₂—OC₆H₅)—OH]],

δ=−79.00 ppm

[2F, Rf—[—CF₂O—CF₂—CH₂—O—CH₂—CH(—CH₂—OC₆H₅)—OH]].

p=10.3, q=11.3.

From the NMR analytical results, it revealed that Compound 1 had a number average molecular weight of 2310.

Subsequently, Compound 1 produced in Example 1 was applied to a magnetic disk to perform a fluidity test of the lubricant film, measurement of the bonded ratio after an ultraviolet treatment, spin-off test of the lubricant film, and thermal stability test of bulk lubricant. The perfluoropolyether compound “Fomblin ZTETRAOL,” produced by Solvay Solexis K.K., was used for comparison (Comparative Example 1). Fomblin ZTETRAOL was produced using Fomblin ZDOL, which is a similar starting material.

### Fluidity Test of Lubricant Film

The diffusion coefficient of the lubricant applied to the surface of a magnetic disk was measured in the same manner as described in JOURNAL of TRIBOLOGY, Vol. 126, 2004, pp. 751-754. More specifically, the diffusion behavior of the lubricant on the disk is measured by observing using an ellipsometer or OSA (optical surface analyzer). The diffusion coefficient was calculated from the following formula using the migration length (L) of the lubricant T hours later.

Diffusion coefficient(mm²/s)=L²/T.

More specifically, Compound 1 produced in Example 1 and Fomblin ZTETRAOL (Comparative Example 1) were individually dissolved in “VERTREL XF,” produced by DuPont. Each of the resulting solutions had a concentration of 0.1% by weight. A part (about ½) of magnetic disks having a diameter of 3.5 inches were individually dipped in each of the solutions and lifted out at 4 mm/s, thereby obtaining disks having a portion to which the lubricant was applied (i.e., lubricant layer), and a portion to which the lubricant was not applied. The portion to which the lubricant was applied had an average thickness of about 30 Å. Immediately after the production of the above disks, the disks were placed in an OSA to periodically measure the change in the film thickness near the boundary between the lubricant-applied portion and non-applied portion under an ordinary temperature. Table 1 shows the results.

TABLE 1

| Test compound | Diffusion coefficient |
|---|---|
| Example 1 (Compound 1) | 0.83 × 10⁻⁵ |
| Comparative Example 1 (ZTETRAOL) | 0.39 × 10⁻⁵ |

As is clear from Table 1, it was confirmed that Compound 1 produced in Example 1 had excellent fluidity on the surface of magnetic disk. Therefore, improvement in the durability of the lubricant layer against the contact with a head and against sliding of head and disk can be expected.

Measurement of Bonded Ratio after Ultraviolet Treatment

Compound 1 produced in Example 1 and Fomblin ZTETRAOL (Comparative Example 1) were individually dissolved in “VERTREL XF,” produced by DuPont. Each of the resulting solutions had a concentration of 0.1% by weight. Magnetic disks having a diameter of 3.5 inches were individually dipped in each of the solutions for 1 minute, and lifted out at 2 mm/s to apply the lubricant thereto. The average film thickness was about 20 Å. The lubricant-applied disks were placed for 10 seconds in an ultraviolet curing unit equipped with a low-pressure mercury lamp emitting ultraviolet having a wavelength of 185 nm and 254 nm. Here, in order to prevent formation of ozone, the atmosphere inside the ultraviolet curing unit was replaced with nitrogen in advance. The thickness of the lubricant after being subjected to UV irradiation was measured by FT-IR (the thickness measured was defined as e). Subsequently, the disks were immersed in VERTREL XF for 1 minute and lifted out at 2 mm/s, and the unadhered lubricant was washed off. The thickness of the lubricant remaining on the disk was measured by FT-IR (the thickness measured was defined as f). The strength of adhesion of the lubricant to the disk was evaluated based on the bonded ratio. The bonded ratio can be calculated from the following formula. Table 2 shows the results.

The bonded ratio(%)=100×f/e

TABLE 2

| Test compound | The bonded ratio (%) |
|---|---|
| Example 1 (Compound 1) | 70 |
| Comparative Example 1 (ZTETRAOL) | 69 |

As is clear from Table 2, it was confirmed that Compound 1 produced in Example 1 can form a lubricant layer strongly adhered on the surface of the magnetic disk by UV irradiation. Because of this, reduction of spin-off of lubricant can be expected.

### Spin-Off Test of Lubricant Film

Compound 1 produced in Example 1 and Fomblin ZTETRAOL (Comparative Example 1) were individually dissolved in “VERTREL XF,” produced by DuPont. Each of the resulting solutions had a concentration of 0.1% by weight. Magnetic disks having a diameter of 3.5 inches were individually dipped in each of the solutions for 1 minute, and lifted out at 2 mm/s to apply the lubricant thereto. The average film thickness was about 20 Å. The lubricant-applied disks were placed for 10 to 20 seconds in an ultraviolet curing unit equipped with a low-pressure mercury lamp emitting ultraviolet having a wavelength of 185 nm and 254 nm. Here, in order to prevent formation of ozone, the atmosphere inside the ultraviolet curing unit was replaced with nitrogen in advance. The irradiation time was adjusted so that the bonded ratio of the lubricant after the UV irradiation became about 70%. The disks thus formed were incorporated in a spin tester, and rotated at 15,000 rpm under a high-humidity and high-temperature environment. The thickness of the lubricant 14 days after the preparation was measured by FT-IR. The strength of spin-off of the lubricant was evaluated based on the spin-off rate. The spin-off rate can be calculated from the following formula. Table 3 shows the results.

Spin-off rate(%)=[1−(thickness 14 days after/initial thickness)]×100

TABLE 3

| Test compound | Spin-off rate (%) |
|---|---|
| Example 1 (Compound 1) | 15 |
| Comparative Example 1 (ZTETRAOL) | 28 |

As is clear from Table 3, Compound 1 produced in Example 1 has excellent low-spin-off properties.

### Thermal Stability Test

2.5 g each of Compound 1 produced in Example 1 and Fomblin ZTETRAOL (Comparative Example 1) was spread on petri dishes having a diameter of 12 cm, and the petri dishes were placed in a 150° C. thermostat and heated for 4 days. After the completion of heating, the lubricant was analyzed by ¹³C-NMR to observe the change in the end groups before and after the heating. Table 4 shows the results.

TABLE 4

| | Change in end groups |
|---|---|
| Test compound | after heating |
| Example 1 (Compound 1) | Not observed |
| Comparative Example 1 (ZTETRAOL) | Observed |

As is clear from Table 4, Compound 1 produced in Example 1 also exhibits excellent stability against heating. Because of this, the provision of a lubricant film that is not easily denaturalized even when used under a high temperature for a long period of time can be attained.

### Example 2

Compound 1 produced in Example 1 was dissolved in “VERTREL XF,” produced by DuPont to prepare a lubricant solution (0.1% by weight). A magnetic disk having a diameter of 3.5 inches comprising a substrate, a recording layer and a protective layer was dipped in the lubricant solution and lifted out at 2 mm/s. The disk was placed for 10 seconds in an ultraviolet curing unit equipped with a low-pressure mercury lamp emitting ultraviolet having a wavelength of 185 nm and 254 nm. Here, in order to prevent formation of ozone, the atmosphere inside the ultraviolet curing unit was replaced with nitrogen in advance. The thickness of the film lubricant formed on the disk was measured by FT-IR. The average film thickness was 20.7 Å.

### EXPLANATION OF NUMERAL SYMBOLS

1 substrate
2 recording layer
3 protective layer
4 lubricant layer

1. A magnetic disk comprising:
a recording layer on a substrate;
a protective layer on the recording layer; and
a lubricant layer on the protective layer,
the lubricant layer being formed by applying, to the surface of the protective layer, a lubricant containing a perfluoropolyether compound represented by Formula (1):
A-O—CH₂—CF₂O—(CF₂CF₂O)ₚ—(CF₂O)_{q}—CF₂—CH₂—O-A (1)
wherein p is an integer of 1 to 30, q is an integer of 0 to 30, and A is a group represented by Formula (2): 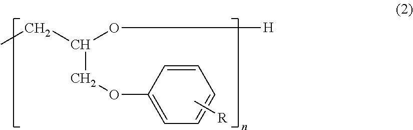
wherein R represents a hydrogen, and n is 1 or 2;
and performing a ultraviolet treatment.

2. A process for producing a magnetic disk having a recording layer on a substrate, a protective layer on the recording layer, and a lubricant layer on the protective layer,
the process comprising forming the recording layer and the protective layer on the substrate in this order,
applying, to the surface of the protective layer, a lubricant containing a perfluoropolyether compound represented by Formula (1):
A-O—CH₂—CF₂O—(CF₂CF₂O)ₚ—(CF₂O)_{q}—CF₂—CH₂—O-A (1)
wherein p is an integer of 1 to 30, q is an integer of 0 to 30, and A is a group represented by Formula (2): 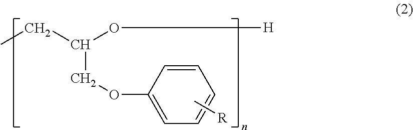
wherein R represents a hydrogen, and n is 1 or 2;
and performing a ultraviolet treatment.

3-5. (canceled)
